(19) United States
(12) Patent Application Publication
(10) Pub. No.: US 2026/0133680 A1
(43) Pub. Date: May 14, 2026

(54) COMPUTER ARCHITECTURE FOR LEARNING MODEL BASED DYNAMIC CONTROL OF A USER INTERFACE

(71) Applicant: Rakuten Group, Inc., Tokyo (JP)

(72) Inventors: Naveen Kumar KAGALAVADI BASAVANNA, Tokyo (JP); Yun Ching Liu, Tokyo (JP)

(73) Assignee: Rakuten Group, Inc., Tokyo (JP)

(21) Appl. No.: 19/371,140

(22) Filed: Oct. 28, 2025

(30) Foreign Application Priority Data
Oct. 29, 2024 (JP) 2024-189658

(51) Int. Cl. G06F 3/04842; G06F 3/0483; G06F 11/34

(52) U.S. Cl. CPC G06F 3/04842; G06F 3/0483; G06F 11/3438

(57) ABSTRACT

A dynamic machine learning model based user interface technology for increased user engagement obtains first data that includes the number of impressions and the number of clicks during a predetermined period with respect to a page display of each of a plurality of interface objects, obtains second data that includes a history regarding interface objects displayed on page displays clicked during the predetermined period, calculates a CTR (Click Through Rate) based on a first machine learning model trained in advance using said first data, a CVR (Conversion Rate) based on a second machine learning model trained in advance using said second data, and a quality score based on a third machine learning model, the quality score representing a balance between CVR (Conversion Rate) and CTR (Click Through Rate) for each of the plurality of interface objects during the predetermined period by using the first data and the second data, and selects a predetermined number of interface objects to be displayed from the plurality of interface objects based on the quality score.

### CROSS-REFERENCE TO RELATED APPLICATION(S)

This application claims priority to Japanese patent application No. 2024-189658, filed on Oct. 29, 2024; the entire contents of which are incorporated herein by reference.

### TECHNICAL FIELD

The present disclosure relates to a computer architecture with machine learning model based dynamic user interface technology for increased user engagement.

### BACKGROUND ART

One example of a type of user interface that can benefit from dynamic control is in the field of electronic commerce (e-commerce), in which products are sold online using the Internet. E-commerce is implemented via a marketplace (e.g., an e-commerce site such as a marketplace type e-commerce site) in which a plurality of stores sell products by displaying the products online, for example. By accessing the marketplace from a personal computer (PC) or a mobile terminal such as a smartphone, a user can browse and purchase a desired product without actually visiting multiple stores or worrying about time.

Merchants (i.e., vendors of products) who sell products in the marketplace distribute advertisements of the products using various online advertising platforms to increase CVR (Conversion Rate) for the products they sell. In an ecommerce context, the CVR is a numerical value indicating the ratio of the number of conversions that merchants envisage, such as purchasing actions and contracts, to the number of accesses (also referred to as “the number of visits” or “the number of sessions”) to a web page (here, a product page for selling a product). In a non-ecommerce context, a CVR is a numerical value indicating the ratio of the number of conversions of an interface object, to the number of accesses (also referred to as “the number of visits” or “the number of sessions”) to a web page. Online advertising platforms are platforms for advertising, distribution, and advertisement analysis services provided online (that is, on a web page), and are implemented by web services such as Google, Facebook, and Yahoo, for example. Merchants can use the online advertising platforms to distribute advertisements of products that may match the interests of users (i.e., web page viewers) through a variety of channels (e.g., video site channels, news site channels, hobbies and preferences site channels) implemented by the web services.

When distributing advertisements of products using page displays (e.g., pages allocated to advertisements and occupying at least part of a web page that the user views) on an online advertising platform, it is effective to distribute advertisements of products having high CVRs when consideration is given to the profits of merchants. On the other hand, the operator of the online advertising platform charges merchants (that is, imposes advertising fees) according to the number of clicks on the page displays of products. Accordingly, it is effective to distribute advertisements of products having high CTRs (Click Through Rates) when consideration is given to the profit of the operator. The CTR is a numerical value indicating the ratio of the number of clicks on a web page to the number of impressions for the web page (i.e., the number of times the web page has been displayed). For merchants, even if the CVR is high, a high CTR leads to an increase in the advertising cost relative to the profit obtained by selling the product, and a reduction in overall revenue. Therefore, there is demand for a technology for creating an advertisement giving consideration to both the CVR and the CTR. For example, JP 2023-168297A discloses a technology for creating an advertisement giving consideration to both the CVR and the CTR.

JP 2023-168297A is an example of related art.

### SUMMARY OF THE DISCLOSURE

The above document discloses a technology for creating an advertisement giving consideration to both the CVR and the CTR. However, there has not been proposed a mechanism for efficiently selecting one or more products to be advertised, giving consideration to a balance between the CVR and the CTR, from among a plurality of candidate products to be advertised.

The present disclosure was made in view of the above problem, and an object of the present disclosure is to provide a technology for efficiently selecting products to be advertised.

In order to solve the above problem, an aspect of a computer architecture according to the present disclosure includes: a first data obtaining unit configured to obtain first data including a number of impressions and a number of clicks during a predetermined period with respect to a page display of each of a plurality of products; a second data obtaining unit configured to obtain second data including a purchase history regarding products advertised on page displays clicked during the predetermined period; a calculation unit configured to calculate a product quality score representing a balance between CVR (Conversion Rate) and CTR (Click Through Rate) for each of the plurality of products during the predetermined period using the first data and the second data; and a selection unit configured to select a predetermined number of products to be advertised from the plurality of products based on the product quality scores.

In order to solve the above problem, an aspect of an information processing method according to the present disclosure includes: obtaining first data including a number of impressions and a number of clicks during a predetermined period with respect to a page display of each of a plurality of products; obtaining second data including a purchase history regarding products advertised on page displays clicked during the predetermined period; calculating a product quality score representing a balance between CVR (Conversion Rate) and CTR (Click Through Rate) for each of the plurality of products during the predetermined period using the first data and the second data; and selecting a predetermined number of products to be advertised from the plurality of products based on the product quality scores.

In order to solve the above problem, an aspect of an information processing program according to the present disclosure is an information processing program for causing a computer to execute information processing including: first data obtaining processing for obtaining first data including a number of impressions and a number of clicks during a predetermined period with respect to a page display of each of a plurality of products; second data obtaining processing for obtaining second data including a purchase history regarding products advertised on page displays clicked during the predetermined period; calculation processing for calculating a product quality score representing a balance between CVR (Conversion Rate) and CTR (Click Through Rate) for each of the plurality of products during the predetermined period using the first data and the second data; and selection processing for selecting a predetermined number of products to be advertised from the plurality of products based on the product quality scores.

According to the present disclosure, it is possible to efficiently select products to be advertised.

A person skilled in the art will be able to understand the above-stated object, aspect, and advantages of the present disclosure, as well as other objects, aspects, and advantages of the present disclosure that are not mentioned above, from the following modes for carrying out the disclosure by referring to the accompanying drawings and claims.

### BRIEF DESCRIPTION OF THE DRAWINGS

FIG. 1 shows an example of a configuration of an information processing system according to an embodiment.

FIG. 2 is a conceptual diagram of overall processing performed by a product list management device, a marketplace operating device, and an advertisement distribution device.

FIG. 3 shows an example of a functional configuration of the product list management device according to an embodiment.

FIG. 4 shows an example of a hardware configuration of the product list management device according to an embodiment.

FIG. 5 shows a flowchart of processing executed by the product list management device according to an embodiment.

FIG. 6 shows an example of product quality scores.

### EMBODIMENTS OF THE DISCLOSURE

The following describes an embodiment of the present disclosure in detail with reference to the accompanying drawings. Constituent elements disclosed below that have the same functions are denoted by the same reference numerals, and redundant descriptions thereof will be omitted. The embodiment disclosed below is an example of implementing the present disclosure, and should be appropriately modified or changed in accordance with the configuration of a device to which the present disclosure is applied and various conditions, and the present disclosure is not limited to the embodiment described below. All combinations of features described in the present embodiment are not necessarily essential to the means for solving the problem according to the present disclosure.

### [Configuration of Information Processing System]

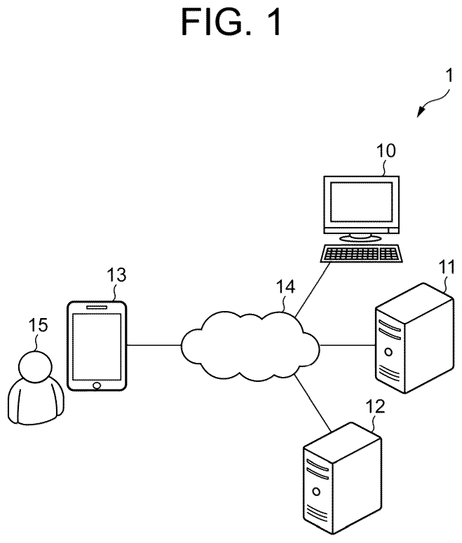

FIG. 1 shows an example of a configuration of an information processing system 1 according to the present embodiment. The information processing system 1 includes a product list management device 10, a marketplace operating device 11, an advertisement distribution device 12, and a user device 13. The product list management device 10, the marketplace operating device 11, the advertisement distribution device 12, and the user device 13 function as information processing devices that can communicate with each other via a network 14. The network 14 can include, in addition to the Internet, an intranet, a LAN (Local Area Network), a WAN (Wide Area Network), a mobile communication network, and the like. Although one user device 13 is illustrated in FIG. 1, the information processing system 1 includes a plurality of user devices (not shown) having functions similar to those of the user device 13, and the plurality of user devices are configured to be capable of communicating with the product list management device 10, the marketplace operating device 11, and the advertisement distribution device 12 via the network 14. The user device 13 is operated by a user 15. In the present disclosure, the terms “user device” and “user” may be understood interchangeably. Further, the product list management device 10 and the advertisement distribution device 12 may be configured as a single device. In addition, the term “product” may be understood to include at least information by which the product can be identified.

The marketplace operating device 11 is a server device that operates and provides a marketplace (e.g., an e-commerce site such as a marketplace type e-commerce site) in which a plurality of stores sell products by displaying the products online. For example, the marketplace operating device 11 operates an e-commerce mall that deploys a shopping mall using sales pages (web pages) of products sold by a plurality of merchants. The marketplace operating device 11 can accept access from the user device 13 via the network 14 and provide various services related to shopping in the marketplace to the user 15. For example, in response to the user 15 accessing the marketplace and taking an action such as purchasing or browsing on a product page for a product (i.e., an online product sales page; the same applies hereinafter), the marketplace operating device 11 provides a service relating to the product to the user 15. Note that the marketplace operating device 11 is not limited to a server device and may be realized by a mainframe or the like.

The advertisement distribution device 12 is a server device that provides an online advertising platform (hereinafter referred to as an “advertising platform”) and distributes advertisements. The advertising platform is a platform for online advertising, distribution, and advertisement analysis services. The advertisement distribution device 12 can distribute an advertisement by placing (i.e., uploading) the advertisement using a banner or the like in a plurality of online channels (e.g., video site channels, news site channels, hobbies and preferences site channels, online map channels, and e-mail channels). Merchants of the marketplace provided by the marketplace operating device 11 can distribute advertisements of products using the advertising platform provided by the advertisement distribution device 12.

When the user 15 clicks on a page display for a product (e.g., a page allocated to an advertisement and occupying at least a region of a web page viewed by the user 15; the same applies hereinafter) distributed by an online channel (hereinafter referred to as a “channel”) and displayed on the user device 13, the page displayed on the user device 13 switches to a landing page corresponding to the advertisement. For example, when the user 15 clicks on a page display for a product sold by a merchant of the marketplace provided by the marketplace operating device 11, the page displayed on the user device 13 switches to a product page for that product.

The advertisement distribution device 12 can place an advertisement of a product in one or more channels selected by a merchant, for example. The merchant can select the channels in which the advertisement is to be placed, considering target users (i.e., a customer group) of the product to be sold. The CVR and the CTR may increase or decrease depending on the channels in which the advertisement of the product is placed, so it is desirable to appropriately select the channels in which the advertisement is to be placed. In addition to or in place of the merchant selecting the channels in which the advertisement is to be placed, the advertisement distribution device 12 or the marketplace operating device 11 may select the channels in which the advertisement is to be placed. Also, the advertisement distribution device 12 or the marketplace operating device 11 may determine the channels in which the 10) advertisement is to be placed through machine learning using user attributes (e.g., demographic information) and history information (e.g., information regarding visiting activities and purchasing activities for a web page, which will be described later) obtained from each user. Note that the advertisement distribution device 12 is not limited to a server device, and may be realized by a mainframe or the like.

The user device 13 is operated by the user 15, and can receive various services by accessing the marketplace provided by the marketplace operating device 11. For example, by operating the user device 13, the user 15 can access the marketplace, browse product pages of various products provided in the marketplace, and purchase products on the product pages. In the present embodiment, in response to the user 15 clicking on a page display of a product distributed by the advertisement distribution device 12 and displayed on the user device 13 (including making an operation for selecting the page display displayed on the screen), the page displayed on the user device 13 switches from the page display to a landing page corresponding to the advertisement, i.e., a product page of the product shown in the page display. In other words, by clicking on a page display, the user 15 can access the product page of the product shown in the clicked page display in the marketplace provided by the marketplace operating device 11. In the present embodiment, it is assumed that the page display directly switches to the landing page in response to a click on the page display, but the page display may switch to the landing page in response to stepwise clicking, that is to say the page display is clicked to move to a web page, and then the web page is clicked.

The user device 13 is a device such as a smartphone or a tablet, for example, and is configured to be capable of communicating with the product list management device 10, the marketplace operating device 11, and the advertisement distribution device 12 via the network 14. The user device 13 includes a display (a display surface) such as a liquid crystal display, and the user 15 can browse information such as a web page displayed on the display. The user 15 can perform various operations using a GUI (Graphical User Interface) provided on the display. Examples of the operations include a tap operation, a slide operation, a scroll operation, etc., performed with a finger, a stylus, or the like with respect to contents such as an image displayed on the screen. The user device 13 may be provided with a separate display.

The marketplace operating device 11 and the advertisement distribution device 12 are configured to collect various types of data through interactions with the user 15 via the user device 13 on a web page. The marketplace operating device 11 and the advertisement distribution device 12 each provide the collected various types of data to the product list management device 10. The following describes data collected by the marketplace operating device 11 and the advertisement distribution device 12. Although the following describes data collected through interactions with the user 15, the marketplace operating device 11 and the advertisement distribution device 12 can collect data through interactions with a plurality of users including the user 15 via a plurality of user devices and provide the collected data to the product list management device 10.

The marketplace operating device 11 collects actions made by the user 15 when browsing a product page as visiting activities. The visiting activities are data indicating actions of the user 15 on a product page of a product sold in the marketplace. The visiting activities can include, for example, the number of accesses to the product page, the time spent on the product page, a page leaving rate, and other patterns of action. The marketplace operating device 11 also collects actions related to purchasing, which is an example of conversion of a product by the user 15, as purchasing activities (also referred to as a “purchase history”). A purchasing activity occurs when the user 15 purchases a product, and is registered as 1 (conversion: Yes) when a product is purchased, and as 0 (conversion: No) when a product is not purchased. A purchasing activity occurs in response to, for example, the user 15 adding a product into a cart on a product page, entering predetermined information, and performing settlement to purchase the product (i.e., executing a purchasing action). The marketplace operating device 11 collects visiting activities and purchasing activities as activity data, and provides the collected activity data to the product list management device 10.

The advertisement distribution device 12 collects the number of times a page display has been displayed on the user device 13 as the number of impressions, and collects the number of clicks made on the page display by the user 15 as the number of clicks. The advertisement distribution device 12 can collect the number of impressions and the number of clicks as ad (advertisement) performance data (hereinafter referred to as “performance data”) for the page display. The performance data can be used to calculate the CTR. The CTR is a numerical value indicating the ratio of the number of clicks to the number of impressions for a web page. In this embodiment, the CTR corresponds to a numerical value indicating the ratio of the number of clicks to the number of impressions for a page display of a product distributed by the advertisement distribution device 12. The advertisement distribution device 12 provides the collected performance data to the product list management device 10. The advertisement distribution device 12 may calculate the CTR and include it in the performance data provided to the product list management device 10.

In the case where a page display directly switches to a landing page (i.e., a product page) in response to a click on the page display as in the present embodiment, the number of accesses to the product page and the number of clicks on the page display mean the same and are the same number. In other words, the number of accesses included in the visiting activities in the activity data and the number of clicks included in the performance data mean the same and are the same number. On the other hand, if a page display switches to a landing page in response to a stepwise click on a web page that was moved to in response to a click on the page display, the number of accesses to the product page may not be the same as the number of clicks on the page display. That is, the number of accesses included in the visiting activities in the activity data may not be the same as the number of clicks included in the performance data.

The product list management device 10 obtains from each merchant a list (hereinafter referred to as a “merchant product list”) of a plurality of (N, which is a natural number of at least 2) products that the merchant can sell in the marketplace operated by the marketplace operating device 11, and holds the list. The merchant product list may be catalog data of the products provided by the merchant. Alternatively, the marketplace operating device 11 may manage the merchant product list and provide it to the product list management device 10. The products included in the merchant product list may be updated at constant intervals of time, for example, and the update may be performed by the product list management device 10 or the marketplace operating device 11 based on an instruction from the merchant.

The product list management device 10 obtains the performance data from the advertisement distribution device 12 and the activity data from the marketplace operating device 11. Then, based on the merchant product list, the performance data, and the activity data, the product list management device 10 calculates a product quality score for each of the N products included in the merchant product list. In this embodiment, the product quality score is a score indicating product quality (or product advertisement quality) from the viewpoint of the CVR and the CTR, and corresponds to a score indicating a balance between the CVR and the CTR. In other words, the product quality score corresponds to a cost that represents a balance between conversion and advertising cost, and a higher product quality score indicates a higher balance, specifically, a relatively high CVR and a relatively high CTR. The product list management device 10 calculates the product quality score using an actual conversion score (CV score) and an actual CTR for each product. The CV score is a score expressing conversion, which is 1 (conversion: Yes) or 0 (conversion: No). A product with a high product quality score is beneficial to merchants because it is possible to expect a high CVR and a high CTR, in other words, a low advertising cost. Such a product can be said to be beneficial to the operator of the advertising platform as well because a high CTR can be expected.

The product list management device 10 selects M (M<N (M is a natural number)) products among the N products included in the merchant product list as a predetermined number of products to be advertised. Then, the product list management device 10 compiles (generates) a list of the M selected products as an optimized product list, and provides the optimized product list to the advertisement distribution device 12. The product list management device 10 can perform processing for calculating the product quality score, selecting products, and compiling and providing the optimized product list with respect to each merchant. A procedure for calculating the product quality score will be described later.

The advertisement distribution device 12, which has obtained the optimized product list, distributes advertisements of the M products included in the list by placing the advertisements on channels. The channels for advertising the M products may be determined using any method, including machine learning. The advertisement distribution device 12 can obtain the optimized product list and distribute advertisements of the M products with respect to each merchant.

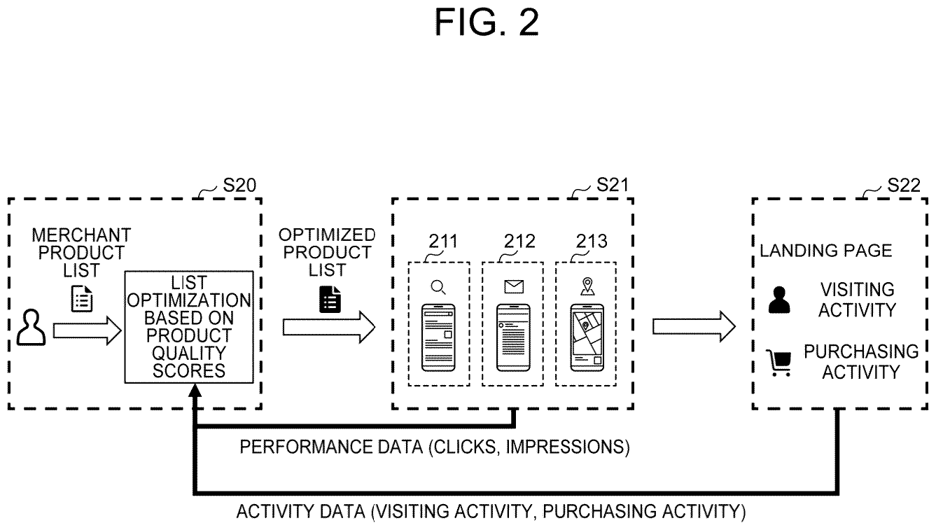

FIG. 2 shows a conceptual diagram of overall processing performed by the product list management device 10, the marketplace operating device 11, and the advertisement distribution device 12 according to the present embodiment. S20 shows processing performed by the product list management device 10, S21 shows processing performed by the advertisement distribution device 12, and S22 shows processing performed by the marketplace operating device 11. The processing in S21, S22, and S20 shown in FIG. 2 will be described in this order. For the explanation of FIG. 2, reference is made to FIG. 1.

In the present embodiment, it is assumed that a predetermined period (hereinafter referred to as a “target period”) for calculating the product quality score for each of the N products is set in advance. The advertisement distribution device 12 and the marketplace operating device 11 collect performance data and activity data during the target period, respectively, and provide the collected data to the product list management device 10. Then, the product list management device 10 calculates product quality scores of the N products during the target period. For example, in a case where the product quality scores are calculated for each day, the target period is a predetermined day. The target period may be set in advance in the product list management device 10, or may be set by an operator, or may be set by a predetermined program, for example.

In S21, the advertisement distribution device 12 provides a plurality of channels in the advertising platform. In the example shown in FIG. 2, a search site channel 211, an e-mail channel 212, and a map site channel 213 are shown. The advertisement distribution device 12 can place (i.e., upload) an advertisement of a product on at least one of the search site channel 211, the e-mail channel 212, and the map site channel 213 to distribute a page display. The advertisement distribution device 12 collects the number of clicks and the number of impressions for the page display in each channel during the target period, generates performance data including the collected number of clicks and the number of impressions, and provides the 10) performance data to the product list management device 10. The advertisement distribution device 12 can obtain an optimized list from the product list management device 10, and place advertisements of M (a plurality of) products included in the optimized list on at least one of the search site channel 211, the e-mail channel 212, and the map site channel 213 to distribute page displays.

In S22, the marketplace operating device 11 collects visiting activities and purchasing activities during the target period on a product page in the provided marketplace, generates activity data including the collected visiting activities and purchasing activities, and provides the activity data to the product list management device 10. In the present embodiment, the product page corresponds to a landing page that is displayed on the user device 13 in response to the user 15 clicking on a page display provided by the advertisement distribution device 12.

In S20, the product list management device 10 obtains a merchant product list from a merchant. The product list management device 10 may obtain the merchant product list from the merchant via another device. Then, the product list management device 10 calculates product quality scores during the target period by using the performance data obtained from the advertisement distribution device 12 and the activity data obtained from the marketplace operating device 11. The procedure for calculating the product quality scores will be described later. Then, the product list management device 10 optimizes the merchant product list using the calculated product quality scores, thereby compiling an optimized product list during the target period. Furthermore, the product list management device 10 provides the compiled optimized product list to the advertisement distribution device 12.

### [Configuration of Product List Management Device]

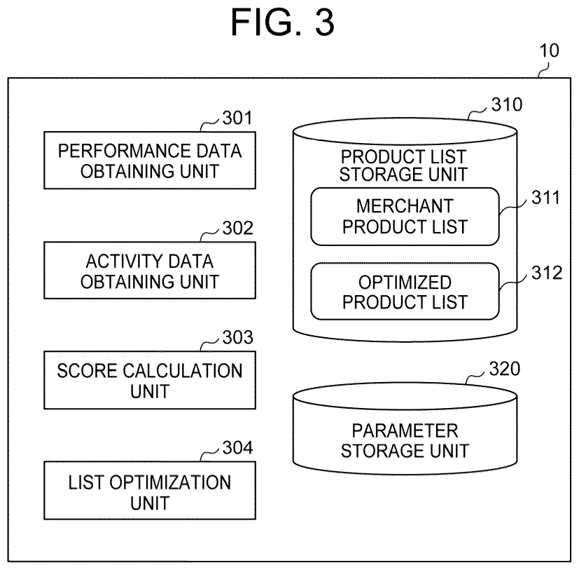

FIG. 3 shows an example of a functional configuration of the product list management device 10 according to the present embodiment. As an example of the functional configuration, the product list management device 10 includes a performance data obtaining unit 301, an activity data obtaining unit 302, a score calculation unit 303, a list optimization unit 304, a product list storage unit 310, and a parameter storage unit 320. The product list storage unit 310 is configured to be capable of storing a merchant product list 311 and an optimized product list 312 for each merchant. FIG. 3 shows a merchant product list 311 and an optimized product list 312 for a merchant. Furthermore, the parameter storage unit 320 is configured to be capable of storing various parameters used for calculating the product quality score.

The performance data obtaining unit 301 obtains performance data during the target period from the advertisement distribution device 12. The performance data includes the number of clicks and the number of impressions during the target period. The activity data obtaining unit 302 obtains activity data during the target period from the marketplace operating device 11. The activity data includes visiting activities and purchasing activities during the target period.

The score calculation unit 303 calculates the product quality score for each of the N products during the target period by using the performance data and activity data obtained from a plurality of users including the user 15. In the present embodiment, the score calculation unit 303 calculates the product quality score based on a bandit algorithm. The bandit algorithm is an algorithm classified as reinforcement learning among machine learning techniques, and aims to maximize a reward while balancing “exploitation” and “exploration”. In the present embodiment, the score calculation unit 303 calculates the product quality score based on a UCB (Upper-Confidence Bound) algorithm among bandit algorithms. In the UCB algorithm, a reward is determined by a value obtained by adding an estimated upper limit score representing uncertainty (a value representing “exploration”) to a score that is based on actual data (a value representing “exploitation”). In the present embodiment, a score obtained by weighting an estimated score by a weight representing uncertainty (specifically, a weight value representing a score upper limit) is used as the estimated upper limit score representing uncertainty.

The score calculation unit 303 calculates a predicted UCB_{cv} (hereinafter referred to as “PUCB_{cv}”) representing a predicted upper limit CV (a predicted upper limit of conversion (e.g., purchasing)) and a predicted UCB_{ctr} (hereinafter referred to as “PUCB_{ctr}”) representing a predicted upper limit CTR (a predicted upper limit of the CTR) for each product in accordance with the UCB algorithm. The predicted upper limit CV may be understood as a predicted upper limit CVR that represents a predicted upper limit of the CVR. Then, the score calculation unit 303 calculates a product quality score PUCB_{ctr} for each product by multiplying the PUCB_{cv} and the PUCB_{ctr}.

The following describes the PUCB_{cv} and the PUCB_{ctr} more specifically. First, the PUCB_{cv} will be described. The score calculation unit 303 calculates PUCB_{cv}(i), which is the PUCB_{cv} of a product i, using an equation (1). The indices i and j used for products in this description are indices representing any of N products included in a merchant product list provided by a merchant.

$$\begin{matrix}[ Equation 1 ] & \\ {PUCB}_{cv} ( i ) = CV ( i ) + {C}_{cv} \cdot {M}_{cv} ( i ) \cdot \frac{\sqrt{{\sum }_{j} {N}_{clk} ( j )}}{1 + {N}_{clk} ( i )} & ( 1 )\end{matrix}$$

On the right-hand side, the first term CV(i) corresponds to a CV score based on actual data, and is 0 or 1. On the right-hand side, the second term C_{cv}·M_{cv}(i)·\sqrt{ΣⱼN_{clk}(j)}/1+N_{clk}(i) corresponds to an estimated upper limit CV representing uncertainty. M_{cv}(i) in the second term represents an estimated CV score as described later, and \sqrt{ΣⱼN_{clk}(j)}/1+N_{clk} (i) represents a weight representing uncertainty. Since the first term and the second term are each expressed by a numerical value from 0 to 1, PUCB_{cv}(i) is also expressed by a numerical value from 0 to 1. The score calculation unit 303 calculates CV(i), M_{cv}(i), N_{clk}(i), and ΣⱼN_{clk} (j) and calculates PUCB_{cv}(i) in accordance with the equation (1) using the calculated values and a fixed parameter C_{cv}.

CV(i) is an actual CV score for the product i. The score calculation unit 303 can obtain CV(i) by using purchasing activities included in the activity data for the product i obtained from the marketplace operating device 11. CV(i) is 1 when at least one user among a plurality of users purchased the product i in the target period, and is 0 when none of the plurality of users purchased the product i. C_{cv} is a fixed value (a hyper parameter) that is a parameter that controls machine learning for M_{cv}(i). N_{clk}(i) represents the number of clicks on the page display of the product i, and ΣⱼN_{clk}(j) represents the total number of clicks on page displays of the N products included in the merchant product list. The score calculation unit 303 can calculate N_{clk}(i) and ΣⱼN_{clk}(j) from the numbers of clicks included in the performance data for the products j (j=1 to N) obtained from the advertisement distribution device 12.

M_{cv}(i) is a CV score for the product i estimated using a learning model for machine learning. In the present embodiment, the score calculation unit 303 can calculate M_{cv}(i) using a trained CV(i) estimation model. The CV(i) estimation model may be a machine learning model based on the CatBoost (Category Boosting) binary classification model in order to estimate whether the product i can acquire conversion at least one time. It is assumed that the CV(i) estimation model is trained in advance using the number of past clicks on the page display of the product i and past purchasing activities for the product i, and parameters for building the CV(i) estimation model derived through the training are stored in the parameter storage unit 320. In the present embodiment, the product list management device 10 uses the number of clicks and purchasing activities collected before the product quality score is calculated for the first time to train the CV(i) estimation model in advance and generate the parameters for building the model, and stores the parameters in the parameter storage unit 320. The training of the CV(i) estimation model may be performed by a device other than the product list management device 10.

Next, the PUCB_{ctr} will be described. The score calculation unit 303 calculates PUCB_{ctr} (i), which is the PUCB_{ctr} of the product i, using an equation (2).

$$\begin{matrix}[ Equation 2 ] & \\ {PUCB}_{c t r} ( i ) = CTR ( i ) + {C}_{ctr} \cdot {M}_{ctr} ( i ) \cdot \frac{\sqrt{{\sum }_{j} {N}_{imp} ( j )}}{1 + {N}_{imp} ( i )} & ( 2 )\end{matrix}$$

On the right-hand side, the first term CTR(i) corresponds to a CTR based on actual data. On the right-hand side, the second term C_{ctr}·M_{ctr}(i)·\sqrt{ΣⱼNᵢₘₚ(j)}/1+Nᵢₘₚ(i) corresponds to an estimated upper limit CTR representing uncertainty. In the second term, M_{ctr}(i) represents an estimated CTR score as described later, and \sqrt{ΣⱼNᵢₘₚ(j)}/1+Nᵢₘₚ(i) represents a weight representing uncertainty. Since the first term and the second term are each expressed by a numerical value from 0 to 1, PUCB_{ctr}(i) is also expressed by a numerical value from 0 to 1. The score calculation unit 303 calculates CTR(i), M_{ctr}(i), Nᵢₘₚ(i), and ΣⱼNᵢₘₚ(j) and calculates PUCB_{ctr}(i) in accordance with the equation (2) using the calculated values and a fixed parameter C_{ctr}.

CTR(i) is an actual CTR of the product i. The score calculation unit 303 can calculate CTR(i) using the number of impressions and the number of clicks included in the performance data regarding the product i obtained from the advertisement distribution device 12. C_{ctr} is a fixed value (a hyper parameter) that is a parameter that controls machine learning for M_{ctr}(i). Nᵢₘₚ(i) represents the number of impressions for the product i, and ΣⱼNᵢₘₚ(j) represents the total number of impressions for the N products included in the merchant product list. The score calculation unit 303 can calculate Nᵢₘₚ(i) and ΣⱼNᵢₘₚ(j) from the numbers of impressions included in the performance data regarding the products j (j=1 to N) obtained from the advertisement distribution device 12.

M_{ctr}(i) is a CTR for the product i estimated using a learning model for machine learning. In the present embodiment, the score calculation unit 303 can calculate M_{ctr}(i) using a trained CTR(i) estimation model. The CTR(i) estimation model may be a machine learning model based on a CatBoost regression model. It is assumed that the CTR(i) estimation model is trained in advance using the number of past clicks and the number of past impressions for the product i, and parameters for building the CTR(i) estimation model derived through the training are stored in the parameter storage unit 320. In the present embodiment, the product list management device 10 uses the number of clicks and the number of impressions collected before the product quality score is calculated for the first time to train the CTR(i) estimation model in advance and generate the parameters for building the model, and stores the parameters in the parameter storage unit 320. The training of the CTR(i) estimation model may be performed by a device other than the product list management device 10.

After calculating the PUCB_{cv}(i) and the PUCB_{ctr}(i), the score calculation unit 303 calculates a product quality score PUCB_{cvtr}(i) for the product i in accordance with an equation (3). That is, the product quality score PUCB_{cvtr}(i) is calculated by multiplying the PUCB_{cv}(i) by the PUCB_{ctr}(i).

$$\begin{matrix}[ Equation 3 ] & \\ {PUCB}_{cvtr} ( i ) = {PUCB}_{cv} ( i ) \cdot {PUCB}_{ctr} ( i ) & ( 3 )\end{matrix}$$

The score calculation unit 303 calculates the product quality score PUCB_{cvtr}(i) during the target period for each of the N products included in the merchant product list 311. The score calculation unit 303 may calculate the product quality score PUCB_{cvtr}(i) periodically, for example, for each target period. For example, if the target period is a predetermined day, the score calculation unit 303 may calculate and update the product quality score PUCB_{ctr}(i) every day.

The list optimization unit 304 selects a predetermined number M (N>M) of products to be advertised out of the N products based on the product quality score PUCB_{cvtr}(i) calculated for each of the N products included in the merchant product list 311. In the present embodiment, the list optimization unit 304 arranges the product quality scores PUCB_{cvtr}(i) in the descending order, and selects M products having higher scores. Note that there is no limitation to the configuration in which M products having higher scores are selected. For example, the list optimization unit 304 may select (M−m) products having higher scores (M>m) and m products having lower scores to verify the balance between conversion and advertising cost.

The list optimization unit 304 may select M products for each target period. In other words, the list optimization unit 304 may select M products each time the product quality score PUCB_{cvtr}(i) is calculated for a target period. Additionally or alternatively, the list optimization unit 304 may select M products for a plurality of target periods. For example, the list optimization unit 304 may average a plurality of product quality scores PUCB_{cvtr}(i) calculated for a plurality of target periods and select M products based on the average PUCB_{ctr}(i). The number M need not be a fixed number, and may be a variable number.

The list optimization unit 304 selects M products from the N products included in the merchant product list 311, and compiles a list of the M products as an optimized product list 312. The list optimization unit 304 can store the optimized product list 312 in the product list storage unit 310, and update the optimized product list 312 each time the product quality scores PUCB_{cvtr}(i) are calculated for the N products. The list optimization unit 304 provides the compiled optimized product list 312 to the advertisement distribution device 12.

### [Hardware Configuration of Product List Management Device]

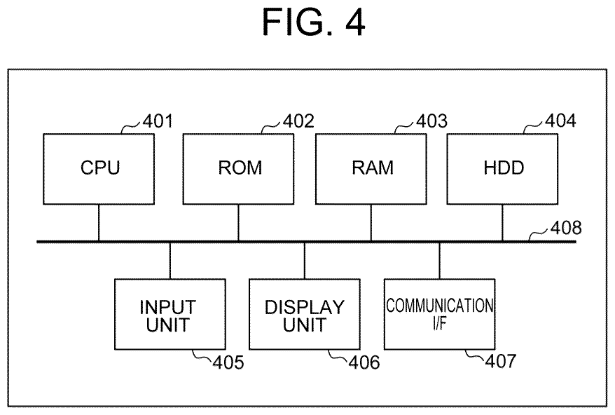

Next, an example of a hardware configuration of the product list management device 10 will be described. FIG. 4 is a block diagram showing an example of the hardware configuration of the product list management device 10 according to the present embodiment.

The product list management device 10 according to the present embodiment can be implemented on one or more computers, mobile devices, or any other processing platforms.

FIG. 4 shows an example in which the product list management device 10 is implemented on a single computer, but the product list management device 10 according to the present embodiment may be implemented on a computer system including a plurality of computers. The computers may be communicably connected to each other by a wired or wireless network.

As shown in FIG. 4, the product list management device 10 may include a CPU (Central Processing Unit) 401, a ROM (Read Only Memory) 402, a RAM (Random Access Memory) 403, an HDD (Hard Disk Drive) 404, an input unit 405, a display unit 406, a communication I/F (interface) (communication unit) 407, and a system bus 408. The product list management device 10 may also be provided with an external memory.

The CPU 401 centrally controls operations of the product list management device 10, and controls the constituent units (402 to 407) via the system bus 408, which is a data transmission path.

The ROM 402 is a non-volatile memory that stores a control program and the like necessary for the CPU 401 to execute processing. The program includes instructions (codes) for executing the processing according to the above embodiment. The program may be stored in a non-volatile memory such as the HDD 404 or an SSD (Solid State Drive), or an external memory such as a removable storage medium (not shown).

The RAM 403 is a volatile memory and functions as a main memory, a work area, and the like of the CPU 401. That is, the CPU 401 loads the necessary program or the like from the ROM 402 into the RAM 403 when executing processing, and executes the program or the like to realize various functional operations. The RAM 403 may include the product list storage unit 310 and the parameter storage unit 320 shown in FIG. 3.

The HDD 404 stores, for example, various types of data and information necessary for the CPU 401 to perform processing using the program. The HDD 404 also stores, for example, various types of data and information obtained by the CPU 401 by performing processing using the program or the like.

The input unit 405 is constituted by a keyboard and a pointing device such as a mouse.

The display unit 406 is constituted by a monitor such as a liquid crystal display (LCD). The display unit 406 may be combined with the input unit 405 to function as a GUI (Graphical User Interface).

The communication I/F 407 is an interface for controlling communication between the product list management device 10 and external devices. The communication I/F 407 provides an interface with a network, and executes communication with external devices via the network. Various types of data and various parameters are transmitted and received to and from external devices via the communication I/F 407. In the present embodiment, the communication I/F 407 may execute communication via a wired LAN (Local Area Network) or a dedicated line that conforms to a communication standard such as Ethernet (registered trademark). However, the network usable in the present embodiment is not limited to this, and may alternatively be a wireless network. Examples of the wireless network include wireless PANs (Personal Area Networks) such as Bluetooth (registered trade mark), ZigBee (registered trade mark), and UWB (Ultra Wide Band). Examples of the wireless network also include a wireless LAN (Local Area Network) such as Wi-Fi (Wireless Fidelity) (registered trademark), and a wireless MAN (Metropolitan Area Network) such as WiMAX (registered trademark). Further, examples of the wireless network include a wireless WAN (Wide Area Network) such as 4G or 5G. It is sufficient that the network connects the devices in a mutually communicable manner and enables communication, and the standard, scale, and configuration of the communication are not limited to those described above.

At least some of the functions of the respective elements of the product list management device 10 shown in FIG. 3 can be realized by the CPU 401 by executing the program. However, at least some of the functions of the elements of the product list management device 10 shown in FIG. 3 may be the operation of dedicated hardware. In this case, the dedicated hardware operates under the control of the CPU 401.

The hardware configurations of the user device 13, the marketplace operating device 11, and the advertisement distribution device 12 may be similar to that shown in FIG. 4.

### [Flow of Processing of Product List Management Device]

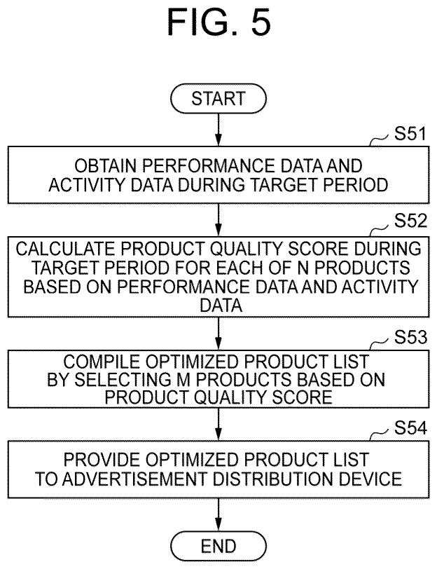

FIG. 5 shows a flowchart of the processing executed by the product list management device 10 according to the present embodiment. In step S51, the performance data obtaining unit 301 obtains performance data during the target period from the advertisement distribution device 12, and the activity data obtaining unit 302 obtains activity data during the target period from the marketplace operating device 11.

In step S52, the score calculation unit 303 calculates product quality scores during the target period for N products based on the performance data and the activity data. The procedure for calculating the product quality scores is as described above. In step S53, the list optimization unit 304 selects M products to be advertised out of the N products based on the calculated product quality scores of the N products, and compiles an optimized product list 312. The list optimization unit 304 may select M products for each target period, or may select M products for a plurality of target periods. In step S54, the list optimization unit 304 provides the compiled optimized product list 312 to the advertisement distribution device 12. Accordingly, the advertisement distribution device 12 can generate and distribute page displays for the M products included in the optimized product list 312. When the product list management device and the advertisement distribution device 12 are configured as a single device, page displays for the M products included in the compiled optimized product list 312 can be distributed.

With this processing, the product list management device 10 can select products for which conversion can be expected with a high probability and a high CTR can be expected, as products to be advertised. In other words, it is possible for merchants to select appropriate products giving consideration to the balance between conversion and advertising cost.

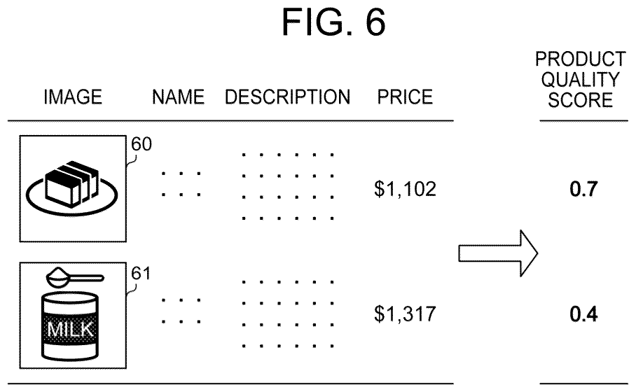

FIG. 6 shows a conceptual diagram of products and product quality scores. In the example shown in FIG. 6, product quality scores are calculated for products 60 and 61, and the product quality score of the product 60 is 0.7 and the product quality score of the product 61 is 0.4. Under such conditions, when the list optimization unit 304 selects either of the two products to compile an optimized product list, the product 60 having the higher product quality score can be selected. Although the price of the product 60 is lower than the price of the product 61, the product quality score of the product 60 is higher, and accordingly, the conversion of the product 60 can be expected with a high probability and a high CTR can be expected, and a high profit can be expected for both the advertisement distributor (e.g., the operator of the advertising platform) and the product provider (e.g., a merchant).

As described above, the product list management device 10 selects, from N products, M (M<N) products for which conversion can be expected with a high probability and a high CTR can be expected, as products to be advertised, and therefore, advertisements can be distributed in a manner that is beneficial to both the advertisement distributor and the product provider, when compared with a case where products to be advertised are selected based on the CVR or the CTR only. Moreover, the product list management device 10 calculates product quality scores using actual data collected by each of the advertisement distributor and the product provider, which are independent organizations, and therefore, it is possible to select products for which the advertising cost and advertising effects are appropriately evaluated with neither the advertisement distributor nor the product provider being favored, and this increases the reliability of the selection. Also, the advertisement distribution device 12 distributes M page displays, the number of which is less than N, rather than page displays of all the N products, and accordingly, the processing load and storage requirements can be reduced, and displays can be intelligently simplified and more focused.

Although the product list is optimized for each merchant in the above embodiment, the present disclosure is not limited to this configuration, and the product list may be optimized 10) for each category, e.g., for each product category. For example, the product list management device 10 may calculate product quality scores of N products included in a certain category in accordance with the above-described procedure, and select M products to be advertised based on the product quality scores. The product list may also be optimized for each merchant and for each category. For example, the product list management device 10 may calculate product quality scores of N products that can be sold by a merchant and are included in a certain category in accordance with the above-described procedure, and select M products to be advertised based on the product quality scores. Although products sold in the marketplace operated by the marketplace operating device 11 are targeted in the above embodiment, this embodiment can be applied to any item that can be sold and purchased online, such as intangible services.

In the above embodiment, visiting activities may be used for the optimization. For example, if a page display switches to a landing page in response to a stepwise click on a web page that was moved to in response to a click on the page display, the number of accesses to the product page included in the visiting activities may be used instead of the number of clicks to the page display when calculating the PUCB_{cv} and PUCB_{ctr} in the equations (1) and (2). It is also possible to calculate weights by quantifying the time spent on the product page, a page leaving rate, and other patterns of action included in the visiting activities, and make the calculated weights reflected in the weights representing uncertainty of the PUCB_{cv} and PUCB_{ctr} in the equations (1) and (2). For example, if the time spent on the product page is longer than a predetermined time, and/or the leaving rate is lower than a predetermined value, the product list management device 10 may determine the weights representing uncertainty such that the weights become larger. As a result, the second term on the right-hand side of each of the equations (1) and (2) becomes larger, and as a result, the product quality score becomes higher.

In the above embodiment, an example is described in which products to be advertised in online page displays are selected, but means for advertising the selected products is not limited to online page displays, and may be, for example, a paper medium or any other medium.

In the above embodiment, the PUCB_{cv} is calculated using the equation (1) and purchasing activities on a product page serving as a landing page, but there is no limitation to the configuration in which purchasing activities on the product page are used, as long as purchasing activities regarding a product can be obtained. For example, the marketplace operating device 11 may register a purchasing activity regarding a product in response to the user 15 purchasing the product using audio or other information given to the user device 13 in response to a click on the page display.

While a specific embodiment is described above, the embodiment is merely illustrative and is not intended to limit the scope of the disclosure. The devices and method described herein may be embodied in forms other than those described above. Further, appropriate omission, substitution, and modification may be made to the above embodiment without departing from the scope of the present disclosure. Such omissions, substitutions, and modifications are within the scope of the claims and their equivalents and are within the technical scope of the present disclosure.

The disclosure includes the following embodiments.

[1] A computer architecture comprising: a first data obtaining unit configured to obtain first data including a number of impressions and a number of clicks during a predetermined period with respect to a page display of each of a plurality of products; a second data obtaining unit configured to obtain second data including a purchase history regarding products advertised on page displays clicked during the predetermined period; a calculation unit configured to calculate a product quality score representing a balance between CVR (Conversion Rate) and CTR (Click Through Rate) for each of the plurality of products during the predetermined period using the first data and the second data; and a selection unit configured to select a predetermined number of products to be advertised from the plurality of products based on the product quality scores.

[2] The computer architecture according to [1], wherein the selection unit selects the predetermined number of products from the plurality of products in a descending order of the product quality scores.

[3] The computer architecture according to [1] or [2], wherein for each of the plurality of products, the calculation unit calculates a predicted upper limit CVR that is a predicted upper limit of the CVR and a predicted upper limit CTR that is a predicted upper limit of the CTR using the first data and the second data, and calculates the product quality score by multiplying the predicted upper limit CVR by the predicted upper limit CTR.

[4] The computer architecture according to any one of [1] to [3], wherein the selection unit selects the predetermined number of products from the plurality of products each time the product quality scores are calculated for the plurality of products.

[5] The computer architecture according to any one of [1] to [3], wherein the selection unit selects the predetermined number of products from the plurality of products each time a plurality of the product quality scores are calculated for the plurality of products.

any one of [1] to [3]

[6] The computer architecture according to any one of [1] to [5], further comprising: an advertisement distribution unit configured to distribute an advertisement for each of the predetermined number of products.

### LIST OF REFERENCE NUMERALS

10: product list management device, 11: marketplace operating device, 12: advertisement distribution device, 13: user device, 14: network, 15: user, 301: performance data obtaining unit, 302: activity data obtaining unit, 303: score calculation unit, 304: list optimization unit, 310: product list storage unit, 311: merchant product list, 312: optimized product list, 320: parameter storage unit

1. A computer architecture for dynamically controlling a user interface comprising:
at least one memory configured to store program code; and
at least one processor configured to operate as instructed by the program code, the program code including;
first data obtaining code configured to cause at least one of the at least one processor to obtain first data including a number of impressions and a number of clicks during a predetermined period with respect to a page display of each of a plurality of interface objects;
second data obtaining code configured to cause at least one of the at least one processor to obtain second data including a history regarding interface objects displayed on page displays clicked during the predetermined period;
calculation code configured to cause at least one of the at least one processor to calculate a CTR (Click Through Rate) based on a first machine learning model trained in advance using said first data, a CVR (Conversion Rate) based on a second machine learning model trained in advance using said second data, and a quality score based on a third machine learning model, the quality score representing a balance between CVR (Conversion Rate) and CTR (Click Through Rate) for each of the plurality of interface objects during the predetermined period using the first data and the second data;
selection code configured to cause at least one of the at least one processor to select a predetermined number of interface objects to be displayed from the plurality of interface objects based on the quality scores; and
display code configured to cause at least one of the at least one processor to transfer information to a device for displaying the selected interface objects.

2. The computer architecture according to claim 1,
wherein the selection code is configured to cause at least one of the at least one processor to select the predetermined number of interface objects from the plurality of interface objects in a descending order of the quality scores.

3. The computer architecture according to claim 1,
wherein for each of the plurality of interface objects, the calculation code causes at least one of the at least one processor to calculate a predicted upper limit CVR that is a predicted upper limit of the CVR and a predicted upper limit CTR that is a predicted upper limit of the CTR using the first data and the second data, and calculates the quality score by multiplying the predicted upper limit CVR by the predicted upper limit CTR.

4. The computer architecture according to claim 1,
wherein the selection code is configured to cause at least one of the at least one processor to select the predetermined number of interface objects from the plurality of interface objects each time the quality scores are calculated for the plurality of interface objects.

5. The computer architecture according to claim 1,
wherein the selection code is configured to cause at least one of the at least one processor to select the predetermined number of interface objects from the plurality of interface objects each time a plurality of the quality scores are calculated for the plurality of interface objects.

6. The computer architecture according to claim 1, further comprising:
distribution code configured to cause at least one of the at least one processor to distribute a display for each of the predetermined number of interface objects.

7. A dynamic display management method executed by at least one computer processor comprising:
obtaining first data including a number of impressions and a number of clicks during a predetermined period with respect to a page display of each of a plurality of interface objects;
obtaining second data including a history regarding interface objects displayed on page displays clicked during the predetermined period;
calculating a CTR (Click Through Rate) based on a first machine learning model trained in advance using said first data, a CVR (Conversion Rate) based on a second machine learning model trained in advance using said second data, and a quality score based on a third machine learning model, the quality score representing a balance between CVR (Conversion Rate) and CTR (Click Through Rate) for each of the plurality of interface objects during the predetermined period using the first data and the second data; and
selecting a predetermined number of interface objects to be displayed from the plurality of interface objects based on the quality scores; and
transmitting information about the selected interface objects to a device for displaying the selected interface objects.

8. A non-transitory computer readable storage medium having computer instructions stored thereon, the computer instructions configured to cause a computer to:
obtain first data including a number of impressions and a number of clicks during a predetermined period with respect to an page display of each of a plurality of image objects;
obtain second data including a history regarding image objects displayed on page displays clicked during the predetermined period;
calculate a CTR (Click Through Rate) based on a first machine learning model trained in advance using said first data, a CVR (Conversion Rate) based on a second machine learning model trained in advance using said second data, and a quality score based on a third machine learning model, the quality score representing a balance between CVR (Conversion Rate) and CTR (Click Through Rate) for each of the plurality of image objects during the predetermined period using the first data and the second data;
select a predetermined number of image objects to be displayed from the plurality of image objects based on the quality scores; and
transmitting information about the selected image objects to a device to provide for displaying of the selected interface objects.
